(19) United States
(12) Patent Application Publication
(10) Pub. No.: US 2010/0201801 A1
(43) Pub. Date: Aug. 12, 2010

(54) IMAGING DEVICE

(76) Inventors: Kenichi Maruyama, Okazaki-shi (JP); Hiroshi Yamakose, Gifu-shi (JP); Shinji Ono, Nagoya (JP); Tetsuro Kato, Nagoya (JP)

Correspondence Address: OSTROLENK FABER GERB & SOFFEN, 1180 AVENUE OF THE AMERICAS, NEW YORK, NY, 100368403, US

(21) Appl. No.: 12/623,915

(22) Filed: Nov. 23, 2009

(30) Foreign Application Priority Data
Feb. 6, 2009 (JP) 2009-26115

(51) Int. Cl. H04N 7/18; H04N 5/225

(52) U.S. Cl. 348/82; 348/335; 348/E05.024

(57) ABSTRACT

An imaging device 100 has a second arm 132 held in a pivotally rotatable manner on an upper end of a first arm 131 that is structured to rise substantially upright from a base 110. The second arm 132 is connected and engaged with a camera head 150. The camera head 150 is aligned with the second arm 132 substantially in parallel with the base 110 to be extended over a specific imaging area SA. The camera head 150 is driven to take an image of a shooting object sheet ST located in the imaging area SA from above the shooting object sheet ST. The first arm 131 has a depressed recess 138 formed on an arm front side thereof. At a storage position of the imaging device 100 where the second arm 132 engaged with the camera head 150 is pivotally rotated to be folded back on the arm front side of the first arm 131, a lens unit CU of the camera head 150 is received in the depressed recess 138 and is surrounded by the peripheral inner wall of the depressed recess 138.

### CROSS-REFERENCE TO RELATED APPLICATIONS

The present application claims the priority based on Japanese Patent Application No. 2009-26115 filed on Feb. 6, 2009, the disclosure of which is hereby incorporated by reference in its entirety.

### BACKGROUND

1. Technical Field

The present invention relates to an imaging device configured to direct an internal camera incorporated in a camera head toward a subject located in a specific imaging area and take an image of the subject.

2. Related Art

These imaging devices are roughly classified into two groups having different structures, one structure equipped with a stage for holding a subject mounted thereon and the other structure without such a stage. Various arrangements and applications have been proposed for the latter structure, because of its advantages, the small size, the light weight, and the easiness of handling (see, for example, JPA 2007-194884).

In the proposed imaging device of the above cited reference, a subject is placed on the upper surface of a table, a desk, or any equivalent, and a camera head is held above a specific imaging area by means of an arm extended from a base installed in the periphery of the specific imaging area. An internal camera incorporated in the camera head held above the specific imaging area is driven to take an image of the subject located in the imaging area. In an inactive state of the imaging device that is not driven to take images, for example, at the time of handling the imaging device for storage or transportation, it is not required to keep the camera head above the specific imaging area. The camera head is thus generally rotated to make a lens of the camera face down.

In the inactive state of the imaging device, the lens of the camera is exposed outside. At the time of handling the imaging device, for example, for storage or transportation, the lens may be carelessly and unintentionally bumped into and damaged by some member or projection placed in the periphery of the imaging device. One possible measure against this potential problem may attach a separate lens cap to the imaging device. This method, however, requires special consideration for preventing the cap from being carelessly lost or from being left somewhere and pays special attention to attachment of the cap at the time of handling the imaging device, for example, for storage or transportation, detachment of the cap at the time of taking images, and removal of the cap from the imaging view field of the camera.

### SUMMARY

It would thus be required to facilitate the handling in an inactive state of an imaging device that is equipped with a camera head supported on a base by means of an arm structure.

The present invention accomplishes at least part of the requirement mentioned above and the other relevant requirements by an imaging device having any of various configurations and arrangements discussed below.

One aspect of the invention is directed to an imaging device configured to direct an internal camera incorporated in a camera head toward a subject located in a specific imaging area and take an image of the subject. The imaging device includes a base installed at a certain position that avoids interfering with the imaging area, and a base-side first arm structured to rise substantially upright from the base. The imaging device also includes a base-side second arm supported on the base-side first arm in a pivotally rotatable manner and structured to change a geometrical position of the base-side second arm by a pivotally rotating motion between a position of making the base-side second arm folded back on the base-side first arm and a position of making the base-side second arm extended over the imaging area. The imaging device further includes a head engagement structure designed to make the camera head engaged with one end of the base-side second arm in the position of making the base-side second arm extended over the imaging area, so as to direct an optical axis of the camera toward the imaging area. The base-side first arm has a recess that is formed on an arm front side, which the base-side second arm is folded back on, and is provided at a specific position that does not interfere with the internal camera of the camera head when the base-side second arm is pivotally rotated with the camera head engaged with the base-side second arm.

In the imaging device according to this aspect of the invention, the base-side first arm is structured to rise substantially upright from the base, which is installed at the certain position that does not interfere with the specific imaging area. The base-side second arm supported on the base-side first arm in a pivotally rotatable manner is extended over the imaging area. The camera head is engaged with and held on one end of the base-side second arm by means of the head engagement structure. The camera head accordingly makes the internal camera face down the imaging area. The imaging device of the invention takes an image of the subject located in the imaging area with the camera from above the subject. In an inactive state of the imaging device that is not driven to take images, the base-side second arm supported on the base-side first arm is pivotally rotated to the position of being folded back on the base-side first arm. The camera head engaged with the base-side second arm is pivotally rotated together with the base-side second arm to an arm front side of the base-side first arm. The base-side first arm has the recess formed on the arm front side at the specific position and shaped such like as avoid interfering with the internal camera of the camera head. A free end or a free end circumference of the internal camera in the camera head is received in the recess and is surrounded by the peripheral inner wall of the recess. In the inactive state of taking no images, the imaging device of the invention readily but effectively protects the internal camera from potential damages by the simple pivotal rotation of the base-side second arm engaged with the camera head to be folded back on the base-side first arm. This arrangement assures the easiness of handling the imaging device. In the inactive state of the imaging device, the base-side second arm engaged with the camera head is folded back on the base-side first arm as explained previously. This geometrical position desirably saves the overall space required for the imaging device in the inactive state.

The imaging device according to the above aspect of the invention may be modified to have any of various additional applications and arrangements discussed below. In one preferable embodiment of the imaging device according to the above aspect of the invention, a through hole is formed in a bottom of the recess to be pierced through the base-side first arm from the arm front side to an arm rear side. As discussed previously, when the base-side second arm is pivotally rotated to the position of being folded back on the base-side first arm, the camera is located at and received in the recess at one end of the through hole. The camera is positioned to have its optical axis pass through the through hole and is driven to take an image of a subject located on the arm rear side via the through hole. It is desirable that the camera facing down the specific imaging area is positioned just opposite to the subject located in the imaging area and that the up-down positional relation in the imaging view field of the camera is identical with the up-down positional relation in the visual field of the user who intends to take an image of the subject located in the imaging area. The user generally views the subject from a position just opposite to the subject. When the base is installed along an up edge of the imaging area (seen from the user), the imaging view field of the camera corresponds to the visual field of the user viewing the subject located in the imaging area. In this state, the up direction of the up-down positional relation in the imaging view field of the camera is practically equal to a direction coming from the camera toward a shaft support of the base-side first arm with the base-side second arm. After the base-side second arm is pivotally rotated to the position of being folded back on the base-side first arm, the internal camera of the camera head may be driven to take an image of a subject located on the arm rear side via the through hole. In this state, the up direction of the up-down positional relation in the imaging view field of the camera is kept equal to the direction coming from the camera toward the shaft support of the base-side first arm with the base-side second arm. The up direction of the up-down positional relation in the imaging view field of the camera is the upward direction seen from the through hole. The camera is positioned just opposite to the subject located on the arm rear side. Namely the up-down positional relation in the imaging view field of the camera in the ordinary state of taking an image of a subject located in the imaging area from above the subject is kept unchanged in the state of taking an image of a subject located on the arm rear side via the through hole formed in the base-side first arm. The direct output of an image signal representing an image taken with the camera has no effect on the up-down positional relation of the taken image. The imaging device of this embodiment accordingly does not require any additional image processing, for example, rotational adjustment of the image signal. This arrangement desirably simplifies the structure of the control circuitry and equipment.

In one preferable application of the imaging device having the through hole, the base-side first arm has an arm base supported in an inclinable manner on the base and is tilted in a preset vertical plane including an optical axis of the internal camera. The tilting motion changes the imaging angle in a vertical direction in the state of taking an image of a subject located on the arm rear side via the through hole formed in the base-side first arm. The imaging device of this arrangement thus effectively widens an imaging area on the arm rear side in the vertical direction.

In one preferable embodiment of the invention, the imaging device further has a switch structured to power on and off the imaging device, wherein the switch functions to keep the imaging device in a power-off state while the imaging device is set at a certain geometrical position, where the base-side second arm is pivotally rotated to be folded back on the base-side first arm and the internal camera of the camera head is held in an attitude of not interfering with the recess. The imaging device of this arrangement is thus readily powered on and off, in conjunction with the pivotal rotation of the base-side second arm.

In another preferable embodiment of the invention, the imaging device further has a lock mechanism configured to keep the imaging device at a certain geometrical position, where the base-side second arm is pivotally rotated to be folded back on the base-side first arm and the internal camera of the camera head is held in an attitude of not interfering with the recess. The imaging device of this embodiment kept at the above geometrical position effectively prevents any unintentional motion of the base-side second arm or the camera head engaged with the base-side second arm at the time of handling the imaging device, for example, for storage or transportation. This arrangement assures the enhanced convenience and the easiness of handling.

### BRIEF DESCRIPTION OF THE DRAWINGS

FIG. 1 is a perspective view illustrating an imaging device 100 in an imaging position, seen from its front side, in a first embodiment of the invention;

FIG. 2 is a side view showing the imaging device 100 in the imaging position;

FIG. 3 is a side view showing the imaging device 100 in a storage position;

FIG. 4 is an explanatory view of a schematic cross section showing the respective constituents of the imaging device 100 in the storage position;

FIG. 5 is a perspective view illustrating an imaging device 100A in an imaging position, seen from its front side, in a second embodiment of the invention;

FIG. 6 is an explanatory view of a schematic cross section showing the respective constituents of the imaging device 100A in a storage position;

FIG. 7 is an explanatory view of a schematic cross section showing tilting motions of a first arm 131 in the imaging device 100A of the second embodiment;

FIG. 8 is an explanatory view showing the mechanical structure and the electrical structure of a main part of an imaging device 100B in one modified example; and

FIG. 9 is an explanatory view of a schematic cross section showing a main part of an imaging device 100C in another modified example.

### DESCRIPTION OF THE PREFERRED EMBODIMENTS

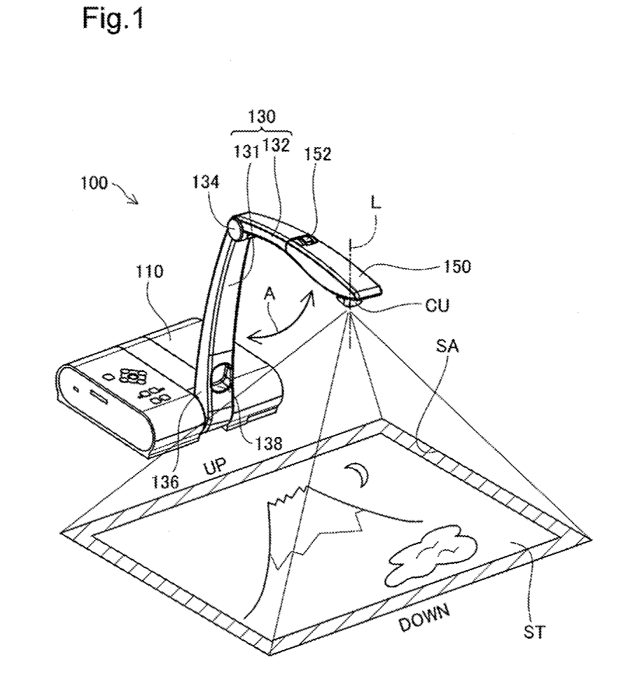

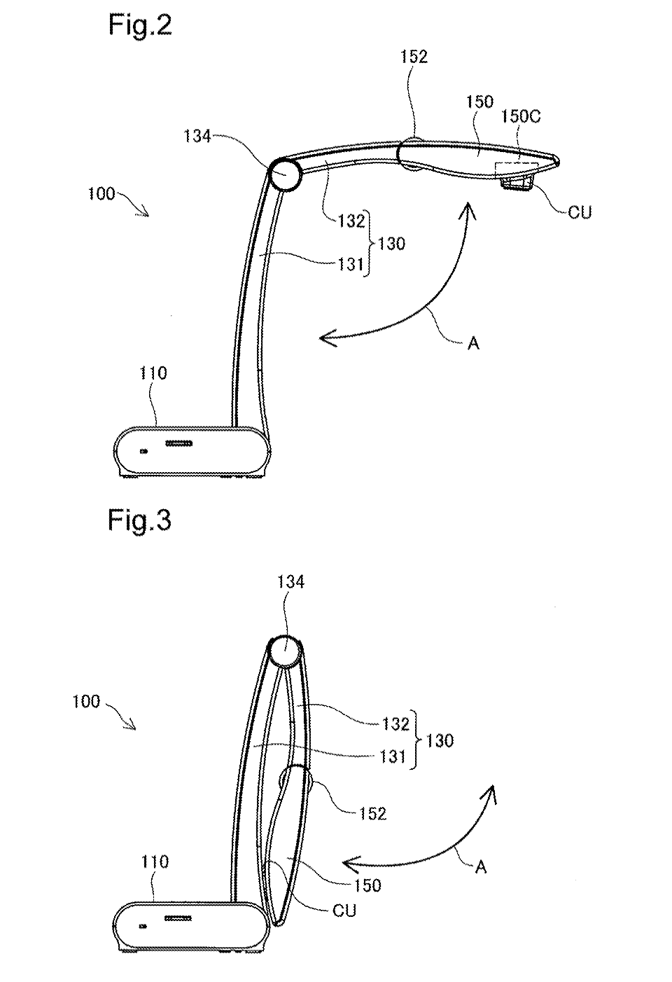

Some modes of carrying out the invention are described below as preferred embodiments with reference to the accompanied drawings. FIG. 1 is a perspective view illustrating an imaging device 100 in an imaging position, seen from its front side, in a first embodiment of the invention. FIG. 2 is a side view showing the imaging device 100 in the imaging position.

As illustrated, the imaging device 100 includes a base 110, a camera support arm 130, and a camera head 150. The base 110 is constructed as a casing of a preset weight to keep the imaging device 100 stable both in an imaging position with the camera head 150 extended and in a storage position with the camera head 150 folded as discussed later. The base 110 has a set of switches including a power switch of the imaging device 100 and a mounting mechanism for a memory card outside of the casing, while having control circuitry and various equipment of the imaging device 100 inside of the casing. These constituents are not directly related to the subject of the invention and are thus not specifically described here.

The camera support arm 130 includes a first arm 131 on the side of the base 110 and a second arm 132 on the side of the camera head 150. The first arm 131 is structured to rise substantially upright from the base 110 and is fastened to the base 110. The camera support arm 130 has a bottomed depressed recess 138, which is formed on an arm front side of an arm base 136 structured as a leg of the first arm 131 fastened to the base 110. The depressed recess 138 will be discussed later in detail.

The second arm 132 is held on an upper end of the first arm 131 by means of a pivot shaft mechanism 134 to be pivotally rotatable in a preset vertical plane in a direction of an arrow A. The pivot shaft mechanism 134 has a known shaft support structure that uses a pivot shaft and a shaft support member with a shaft hole for receiving the pivot shaft fitted therein and rotates the pivot shaft relative to the shaft support member. The pivot shaft mechanism 134 has a clicking structure (not shown) that sets the geometrical position of the second arm 132 selected between an imaging position and a storage position. In the imaging position, the second arm 132 is kept substantially horizontally to be extended over a specific imaging area SA in front of the base 110 as shown in FIGS. 1 and 2. In the storage position, on the other hand, the second arm 132 is folded back on the first arm 131 as described later. The user pivotally rotates the second arm 132 to a desired geometrical position selected between the imaging position and the storage position. When sensing a click-like sound, the user stops a further pivotal rotation but holds the second arm 132 in the selected geometrical position. The pivotal rotation of the pivot shaft mechanism 134 changes the geometrical position of the second arm 132 between the imaging position shown in FIGS. 1 and 2 and the storage position where the second arm 132 is folded back on the first arm 131.

The camera head 150 is interconnected and engaged with an end of the second arm 132 by means of a head engagement mechanism 152 to be extended from the second arm 132. The head engagement mechanism 152 has a known engagement structure that uses a shaft and a shaft support member with a shaft hole for receiving the shaft fitted therein. The camera head 150 has a lens unit CU provided on its free end. The lens unit CU has an edge section that is formed to surround an internal camera 150C and is protruded from a lower face of the free end of the camera head 150. In the imaging position shown in FIGS. 1 and 2, the camera head 150 directs an optical axis L of the camera in the lens unit CU toward the specific imaging area SA and positions the camera 150C just opposite to a shooting object sheet ST located in the specific imaging area SA. The camera 150C is then driven to take an image of the shooting object sheet ST from above the shooting object sheet ST. In this imaging position, the imaging view field of the camera 150C corresponds to the visual field of the user facing the base 110 across the imaging area SA. The up direction of the up-down positional relation in the imaging view field of the camera 150C is thus practically equal to a direction coming from the camera 150C toward the pivot shaft mechanism 134 at the shaft support position between the second arm 132 and the first arm 131. The camera 150C is constructed as an automatic focusing camera having a zooming function. Components required for such auto focusing and zooming functions, for example, an automatic focus button and a zoom dial (not shown), are provided on suitable locations of the camera head 150, for example, a side face of the camera head 150 and a top face of the base 110.

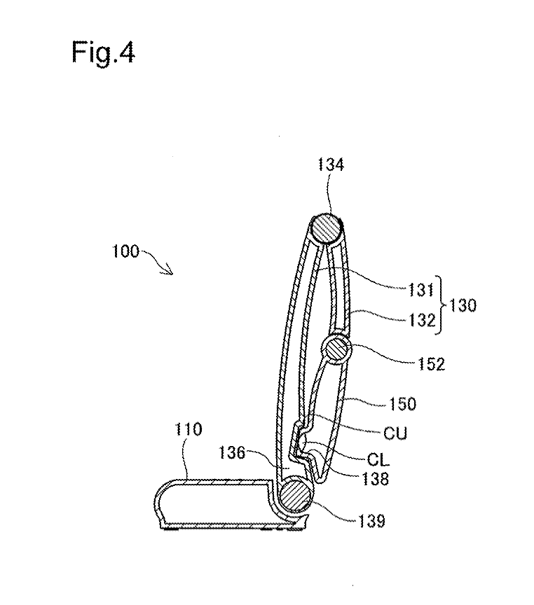

The geometrical position of the second arm 132 is changed from the imaging position shown in FIGS. 1 and 2 to the storage position. FIG. 3 is a side view showing the imaging device 100 in the storage position. FIG. 4 is an explanatory view of a schematic cross section showing the respective constituents of the imaging device 100 in the storage position. In the illustrated storage position, the second arm 132 interconnected and engaged with the camera head 150 by means of the head engagement mechanism 152 pivotally rotates about the pivot shaft mechanism 134 to be folded back on the arm front side of the first arm 131. The edge section of the lens unit CU surrounding the camera is protruded from the lower face of the camera head 150.

The depressed recess 138 provided on the arm front side of the first arm 131 is formed to have a greater diameter than the diameter of the protruded edge section of the lens unit CU. The position of the depressed recess 138 is determined to be located on a trajectory of the pivotally rotating edge section of the lens unit CU about the pivot shaft mechanism 134. As shown in FIGS. 3 and 4, in the storage position where the second arm 132 engaged with the camera head 150 is pivotally rotated to be folded back on the arm front side of the first arm 131, the protruded edge section of the lens unit CU is received in the depressed recess 138 and is surrounded by the peripheral inner wall of the depressed recess 138. In an inactive state of taking no images, the imaging device 100 of the embodiment readily but effectively protects the camera or more specifically a camera lens CL in the edge section of the lens unit CU from potential damages by the simple pivotal rotation of the second arm 132 to the storage position shown in FIGS. 3 and 4. This arrangement assures the easiness of handling. In the storage position shown in FIGS. 3 and 4, the second arm 132 engaged with the camera head 150 is folded back on the arm front side of the first arm 131. This geometrical position desirably saves the overall space required for the imaging device 100 in the inactive state. The simple pivotal rotation of the second arm 132 engaged with the camera head 150 changes the geometrical position from the storage position shown in FIGS. 3 and 4 to the imaging position shown in FIGS. 1 and 2 and enables the camera of the camera head 150 to be promptly driven to take an image of the shooting object sheet ST located in the specific imaging area SA.

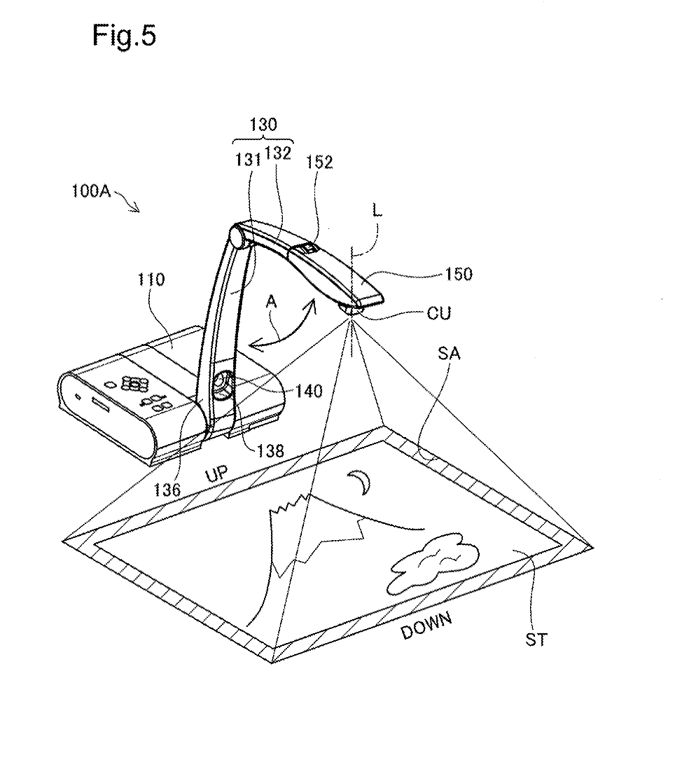

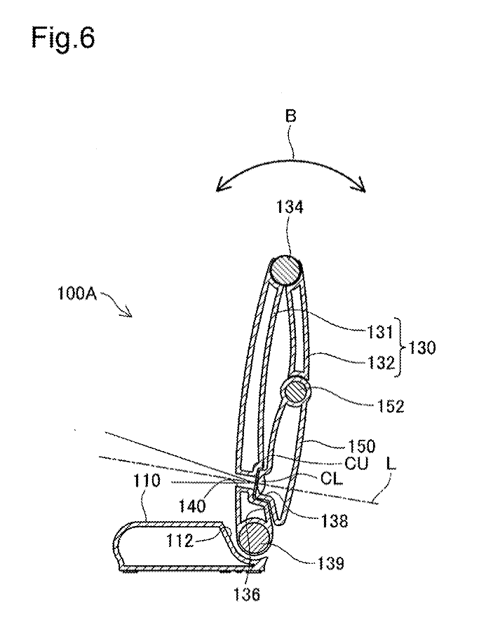

Another embodiment in accordance with the invention is described below. FIG. 5 is a perspective view illustrating an imaging device 100A in an imaging position, seen from its front side, in a second embodiment of the invention. FIG. 6 is an explanatory view of a schematic cross section showing the respective constituents of the imaging device 100A in a storage position. FIG. 5 and FIG. 6 of the second embodiment respectively correspond to FIG. 1 and FIG. 4 of the first embodiment. The like elements of the second embodiment to those of the first embodiment are expressed by the like numerals and symbols and are not specifically explained here. The primary feature of the second embodiment is that the imaging device 100A is capable of taking an image of a subject even in the storage position.

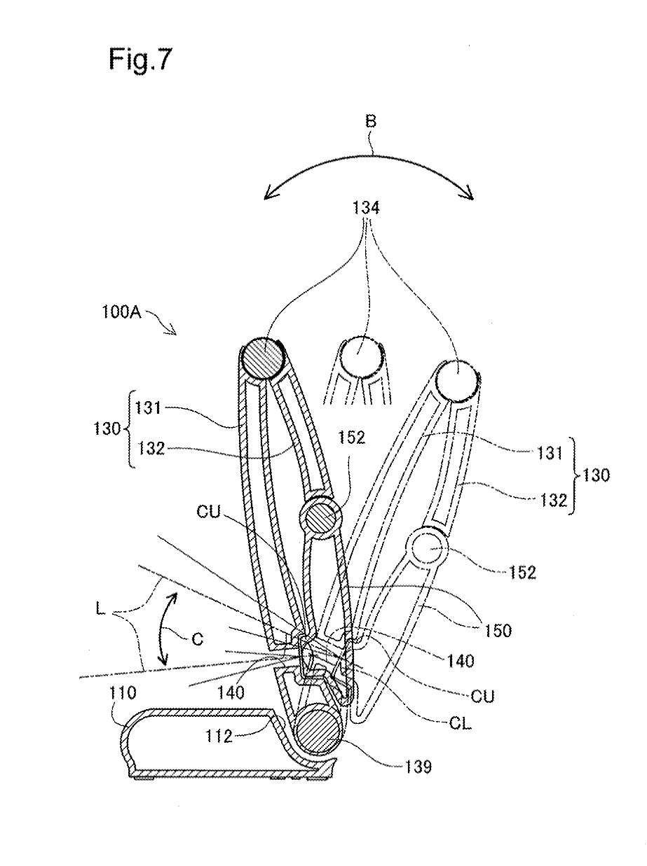

As illustrated in FIG. 5, the imaging device 100A has a through hole 140 that is formed in a bottom of a depressed recess 138 provided on an arm front side of a first arm 131 and is pierced through the first arm 131 from an arm front side to an arm rear side. The first arm 131 is supported by a tilting mechanism 139 to be inclinable relative to a base 110. The tilting mechanism 139 is provided on a front edge of the base 110 to support a lower end of the first arm 131 in a width direction of the base 110 or in a sheet piercing direction of FIG. 6. The first arm 131 is accordingly tilted back and forth relative to the base 110 in a direction of an arrow B as shown in FIG. 6. The range of the forward tilting motion away from the base 110 and the range of the backward tilting motion toward the base 110 are restricted by an angle controller (not shown) provided in the tilting mechanism 139. The first arm 131 is configured to be tilted in this restricted angle range, for example, to be tilted forward (in the direction away from the base 110) in a preset angle range of, for example, about 5 degrees and backward (in the direction toward the base 110) in a preset angle range of, for example, about 45 degrees. The tilting mechanism 139 is designed to hold the first arm 131 at any arbitrary position in the restricted angle range of the forward tilting motion and the backward tilting motion. FIG. 7 is an explanatory view of a schematic cross section showing the tilting motions of the first arm 131 in the imaging device 100A. As shown in FIGS. 6 and 7, the base 110 has a slope section 112, which is formed to face the tilting mechanism 139 and to allow for the tilting motion of the first arm 131 in the direction toward the base 110.

As in the imaging device 100 of the first embodiment, in the imaging device 100A of the second embodiment, a protruded edge section of a lens unit CU is received in the depressed recess 138 and is surrounded by the peripheral inner wall of the depressed recess 138 in the storage position. In the storage position, a camera (not shown) of the lens unit CU is located inside the depressed recess 138 at one end of the through hole 140 and is positioned to make an optical axis L of the camera pass through the through hole 140. In the imaging device 100A of the second embodiment, the camera is driven to take an image of a subject located on an arm rear side of the first arm 131 via the through hole 140 in the storage position.

As discussed previously with reference to FIG. 1, in the imaging position shown in FIG. 5, the camera head 150 positions the camera just opposite to a shooting object sheet ST located in a specific imaging area SA. The imaging view field of the camera corresponds to the visual field of the user facing the base 110 across the imaging area SA. The up direction of the up-down positional relation in the imaging view field of the camera is thus practically equal to the direction coming from the camera toward a pivot shaft mechanism 134. In the state of taking an image of a subject located on the arm rear side of the first arm 131 via the through hole 140 in the storage position shown in FIGS. 6 and 7, the up direction of the up-down positional relation in the imaging view field of the camera of the lens unit CU received in the depressed recess 138 is kept practically equal to the direction coming from the camera toward the pivot shaft mechanism 134. In the state of taking an image of the subject located on the arm rear side of the first arm 131 via the through hole 140 in the storage position, the up direction of the up-down positional relation in the imaging view field of the camera is the upward direction seen from the through hole 140. The camera is positioned just opposite to the subject located on the arm rear side of the first arm 131. In the imaging device 100A of this embodiment, the up-down positional relation in the imaging view field of the camera in the ordinary state of taking an image of a subject located in the specific imaging area SA (for example, the shooting object sheet ST shown in FIG. 5) from above the imaging area SA is accordingly kept unchanged in the state of taking an image of a subject located on the arm rear side of the first arm 131 via the through hole 140 in the storage position. In the imaging device 100A of this embodiment, the direct output of image signals representing images taken with the camera without any additional image processing causes no change of the up-down positional relation between an image of a subject in the imaging area SA taken in the ordinary imaging position and an image of a subject on the arm rear side taken in the storage position. Namely the imaging device 100A of the second embodiment does not require any additional image processing, for example, rotational adjustment of the image signals. This arrangement desirably simplifies the structure of the control circuitry and equipment, while allowing for both taking an image of the subject located in the imaging area SA in front of the base 110 and taking an image of the subject located on the arm rear side of the first arm 131.

In the imaging device 100A of the second embodiment, the first arm 131 is inclinable back and forth on its lower end relative to the base 110 in the direction of the arrow B as shown in FIGS. 6 and 7. The camera of the lens unit CU received in the depressed recess 138 follows the tilting motion of the first arm 131 and is tilted in a preset vertical plane including the optical axis L of the camera in a direction of an arrow C shown in FIG. 7. In the state of taking an image of a subject located on the arm rear side of the first arm 131 via the through hole 140, the imaging angle is thus variable in the vertical direction as shown in FIG. 7. The imaging device 100A of this embodiment expands the imaging area in the vertical direction in the state of taking an image of the subject located on the arm rear side of the first arm 131. This arrangement assures the enhanced convenience and the easiness of handling.

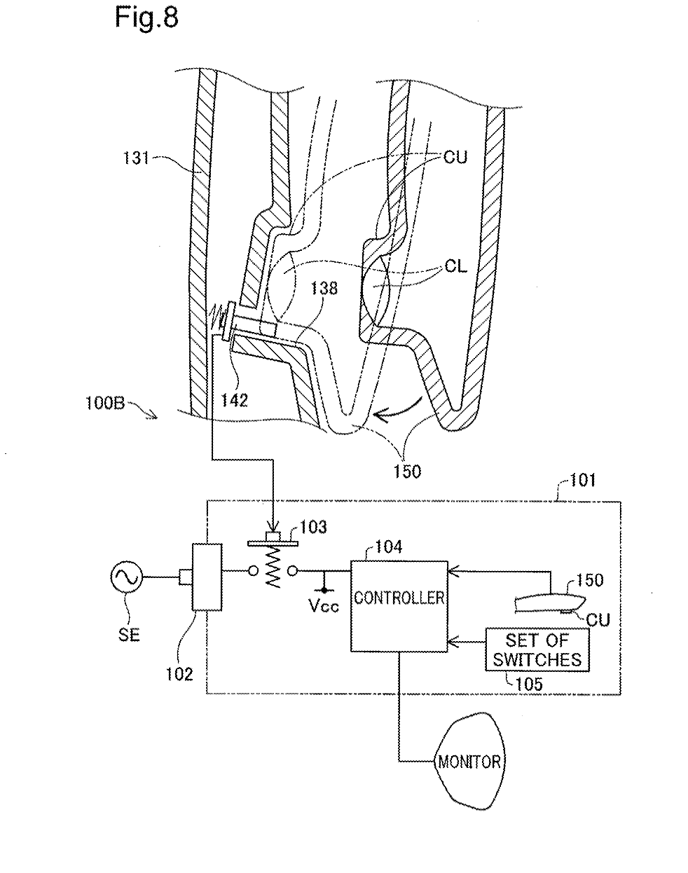

Some examples of possible modification are discussed below. FIG. 8 is an explanatory view showing the mechanical structure and the electrical structure of a main part of an imaging device 100B in one modified example. The primary feature of this modified example is power on-off control accompanied with a change of the geometrical position between the ordinary imaging position and the storage position where the edge section of the lens unit CU is received in the depressed recess 138.

As shown in FIG. 8, the first arm 131 has a switch driving unit 142 provided on the bottom of the depressed recess 138. Under application of a pressing force of a spring, the switch driving unit 142 is protruded from the bottom of the depressed recess 138. The switch driving unit 142 is retreated to a position concealed in the bottom of the depressed recess 138 and is restored to an original position protruded from the bottom of the depressed recess 138, in response to insertion and release of the edge section of the lens unit CU into and from the depressed recess 138.

A power unit 101 of the imaging device 100B receives electric power from a commercial power supply SE via a connector 102 and a switch 103 and supplies a voltage-converted and DC-converted device-driving electric power to a controller 104 and to the lens unit CU of the camera head 150. In response to a switching operation of any switch included in a set of various switches 105 provided on the base 110, the controller 104 performs a relevant device control operation. The controller 104 also functions to output an image signal representing an image taken with the lens unit CU of the camera head 150 to a monitor without any additional image processing, such as rotational adjustment. The switch 103 is constructed as a spring back-type switch and opens and closes a circuit structure, in response to the retreat action and the restoration action of the switch driving unit 142 into and from the depressed recess 138. Namely the switch 103 is driven to open the circuit structure, when the switch driving unit 142 is pressed by the edge section of the lens unit CU received in the depressed recess 138 and is retreated into the position concealed in the bottom of the depressed recess 138. The switch 103 is driven to close the circuit structure, when the switch driving unit 142 is restored to the original position protruded from the bottom of the depressed recess 138. In the imaging device 100B of the modified example, in the inactive state or in the storage position where the second arm 132 engaged with the camera head 150 is folded back on the first arm 131 as shown in FIG. 3, the switch 103 is set in the circuit open position to keep the imaging device 100B in the power-off state. When the second arm 132 engaged with the camera head 150 is pivotally rotated to change the geometrical position from the storage position to the imaging position shown in FIG. 1, on the other hand, the switch 103 is set in the circuit closed position to supply the power to the imaging device 100B. The imaging device 100B of this modified example is thus readily powered on and off, in conjunction with the pivotal rotation of the second arm 132.

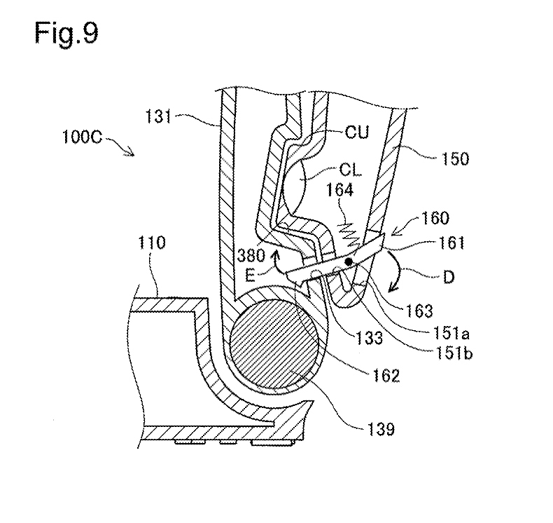

FIG. 9 is an explanatory view of a schematic cross section showing a main part of an imaging device 100C in another modified example. The primary feature of this modified example is a mechanism for keeping and releasing a storage position.

In the illustrated state of FIG. 9, the imaging device 100C of the modified example is set in the storage position. The imaging device 100C has a lock mechanism 160 provided on one end of the camera head 150 (a lower end in FIG. 9). The lock mechanism 160 has an operational piece 161 and an engagement piece 162 that are interconnected swingably about a supporting point 163. The operational piece 161 is protruded out of an aperture 151a formed on the end of the camera head 150 and is pulled upward by means of a spring 164. In the lock mechanism 160 of this structure, the pressing force of the spring 164 keeps the operational piece 161 at an illustrated position on an upper end of the aperture 151a. The engagement piece 162 is protruded out of an aperture 151b in an opposite direction to the protruding direction of the operational piece 161 and is inserted into an engagement aperture 133 formed in the first arm 131. In the lock mechanism 160 of this structure, under application of the pressing force of the spring 164, the engagement piece 162 swings about the supporting point 163 and is kept at an illustrated position on a lower end of the engagement aperture 133. The engagement piece 162 has a catch-like end projection caught at the lower end of the engagement aperture 133. The engagement piece 162 is accordingly kept in the engaged state with the lower end of the engagement aperture 133.

The imaging device 100C of this modified example changes the geometrical position between the imaging position and the storage position as discussed below. In the illustrated state of FIG. 9, when the user presses down the operational piece 161 in a direction of an arrow D against the pressing force of the spring 164, the engagement piece 162 swings up in a direction of an arrow E toward a position on an upper end of the engagement aperture 133 to release the engagement with the engagement aperture 133. The user lifts up the camera head 150 in a pivotally rotating direction (that is, in an upper right direction in FIG. 9). The camera head 150 engaged with the second arm 132 (see FIG. 1) is then pivotally rotated via the support shaft mechanism 134 (see FIG. 1) to change the geometrical position to the imaging position as shown in FIG. 1. When the camera head 150 engaged with the second arm 132 is pivotally rotated to change the geometrical position from the imaging position shown in FIG. 1 to the storage position shown in FIG. 3, on the other hand, the engagement piece 162 interferes with the lower end of the engagement aperture 133 formed in the first arm 131. The engagement piece 162 receives an interference-induced force and swings up to the upper end of the engagement aperture 133. In response to cancellation of the interference of the engagement piece 162 with the lower end of the engagement aperture 133, the engagement piece 162 swings about the supporting point 163 under application of the pressing force of the spring 164. The catch-like end projection of the engagement piece 162 is then engaged with the lower end of the engagement aperture 133 and keeps this state of engagement. In the imaging device 100C of this modified example, as the second arm 132 pivotally rotates to change the geometrical position to the storage position, the lock mechanism 160 functions to keep the storage position. The structure of the imaging device 100C thus effectively locks the second arm 132 and the camera head 150 and prevents any unintentional motion of the second arm 132 or the camera head 150 at the time of handling the imaging device 100C, for example, for storage or transportation. This arrangement assures the enhanced convenience and the easiness of handling.

The various modes, embodiments and modified examples discussed above are to be considered in all aspects as illustrative and not restrictive. There may be many other modifications, changes, and alterations without departing from the scope or spirit of the main characteristics of the present invention. In one example, the lock mechanism 160 may be provided on the side of the first arm 131, instead of the end of the camera head 150. In another example, the depressed recess 138 may be formed as a through hole of a constant diameter that is pierced through the first arm 131 from the arm front side to the arm back side.

What is claimed is:

1. An imaging device configured to direct an internal camera incorporated in a camera head toward a specific imaging area and take an image, the imaging device comprising:
a base installed at a certain position that avoids interfering with the imaging area;
a base-side first arm structured to rise substantially upright from the base;
a base-side second arm supported on the base-side first arm in a pivotally rotatable manner and structured to change a geometrical position of the base-side second arm by a pivotally rotating motion between a position of making the base-side second arm folded back on the base-side first arm and a position of making the base-side second arm extended over the imaging area; and
a head engagement structure designed to make the camera head engaged with one end of the base-side second arm in the position of making the base-side second arm extended over the imaging area, so as to direct an optical axis of the camera toward the imaging area,
wherein the base-side first arm has a recess that is formed on an arm front side, which the base-side second arm is folded back on, and is shaped such like as avoid interfering with the internal camera of the camera head when the base-side second arm is pivotally rotated with the camera head engaged with the base-side second arm.

2. The imaging device in accordance with claim 1, wherein a through hole is formed in a bottom of the recess to be pierced through the base-side first arm from the arm front side to an arm rear side.

3. The imaging device in accordance with claim 2, wherein the base-side first arm has an arm base supported in an inclinable manner on the base and is tilted in a preset vertical plane including an optical axis of the internal camera.

4. The imaging device in accordance with claim 1, the imaging device further having a switch structured to power on and off the imaging device, the switch functioning to keep the imaging device in a power-off state while the imaging device is set at a certain geometrical position where the base-side second arm is pivotally rotated to be folded back on the base-side first arm and the internal camera of the camera head is held in an attitude of not interfering with the recess.

5. The imaging device in accordance with any one of claims 1 through 4, the imaging device further having a lock mechanism configured to keep the imaging device at a certain geometrical position, where the base-side second arm is pivotally rotated to be folded back on the base-side first arm and the internal camera of the camera head is held in an attitude of not interfering with the recess.
